(19) United States
(12) Patent Application Publication
(10) Pub. No.: US 2011/0054945 A1
(43) Pub. Date: Mar. 3, 2011

(54) EXAM SHEET HANDLING SYSTEM AND METHOD

(76) Inventor: Xiaoyan Wang, Beijing (CN)

(21) Appl. No.: 12/868,392

(22) Filed: Aug. 25, 2010

(30) Foreign Application Priority Data
Aug. 25, 2009 (CN) 200910167494.1

(51) Int. Cl. G06Q 50/00; G06Q 10/00

(52) U.S. Cl. 705/3

(57) ABSTRACT

An exam sheet handling system includes a subscription unit configured for setting subscription conditions for doctors and a distribution unit configured for distributing exam sheets to Worklist of the doctors in accordance with the subscription conditions and a distribution principle.

### CROSS REFERENCE TO RELATED APPLICATIONS

This application claims the benefit of Chinese Patent Application No. 200910167494.1 filed Aug. 25, 2009, which is hereby incorporated by reference in its entirety.

### BACKGROUND OF THE INVENTION

Embodiments described herein generally relate to the medical field, in particular relates to an exam sheet handling system and method used in the medical diagnosis and examination field, the exam sheet herein refers to result data, parameters, and/or pictures obtained from medical means of various exams and/or tests implemented by a medical system.

In the medical field, conducting exams on patients, for example, conducting exams such as an electrocardiogram, a blood routine, a urine routine, is usually a necessary step. After having completed conducting the exams on the patients, a doctor needs to make an analysis and judgment of data on the exam sheet and give a report for the exams.

At present, exam sheets of patients are usually placed at a work table and such place, a doctor needs to go to the work table, select exam sheets that are close to the field he belongs to and he experts at from numerous exam sheets, then make an analysis and judgment of data on the exam sheets and give report for the exams.

However, because a doctor needs to manually select exam sheets adapted to him from numerous exam sheets, the work efficiency of the doctor is greatly decreased. Moreover, because a doctor makes selection manually, he will miss some exam sheets at times. Therefore, some exam sheets are not handled by the doctor for a long period of time.

### BRIEF DESCRIPTION OF THE INVENTION

One technical problem to be solved by the present invention is to provide an exam sheet handling system and method with high work efficiency.

Accordingly, one technical solution of the exam sheet handling system of the present invention is a subscription unit configured for setting subscription conditions for doctors, and a distribution unit configured for sending exam sheets to Worklist of the doctors in accordance with the subscription conditions and a distribution principle.

In some embodiments, the exam sheet handling system also comprises a subscription change unit configured for changing the subscription conditions.

Further, the exam sheet handling system also comprises a subscription stop unit configured for disabling said distribution unit and a subscription continue unit configured for enabling said distribution unit.

Further, the exam sheet handling system also comprises a forward unit configured for forwarding exam sheets in said Worklist to other Worklist.

Further, the exam sheet handling system also comprises a check unit configured for checking whether exam sheets in said Worklist satisfy said subscription conditions and removing or maintaining said exam sheets in accordance with instructions of the doctors.

In some embodiments, the distribution principle is configurable.

In some embodiments, the distribution principle includes distributing new exam sheets evenly to doctors who have subscribed the exam sheets.

In some embodiments, the distribution principle includes distributing new exam sheets to the doctor who has the minimal uncompleted workload in his Worklist among doctors who have subscribed the exam sheets.

Correspondingly, one technical solution of the exam sheet handling method of the present invention includes setting subscription conditions for doctors and sending exam sheets to Worklist of the doctors in accordance with the subscription conditions and a distribution principle.

In some embodiments, the exam sheet handling method also includes subscription change step for changing the subscription conditions.

Further, the exam sheet handling method also comprises subscription stop step for disabling said distribution step and subscription continue step for enabling said distribution step.

Further, the exam sheet handling method also comprises forward step for forwarding exam sheets in said Worklist to other Worklist.

Further, the exam sheet handling method also comprises a check step for checking whether exam sheets in said Worklist satisfy said subscription conditions and removing or maintaining said exam sheets in accordance with instructions of the doctors.

In some embodiments, the distribution principle is configurable.

On the other hand, the present invention further discloses an exam sheet handling system, including a first interface configured for setting subscription conditions, wherein the first interface comprising role of doctors, time range of exams and type of exams. The exam sheet handling system also includes several second interfaces corresponding to each of the doctors, wherein the second interfaces include Worklist of doctors. The exam sheet handling system further includes a distribution unit configured for sending exam sheets to the Worklist in the second interfaces in accordance with the subscription conditions set by the first interface and a distribution principle.

In some embodiments, the first interface is also configured to change subscription conditions.

In some embodiments, the second interfaces also comprise an option for disabling the distribution unit from sending exam sheets to the Worklist therein.

Further, the exam sheet handling system also comprises a third interface for forwarding exam sheets in said Worklist to Worklist in the second interfaces that other doctors correspond to, said third interface being invoked by said second interfaces.

In some embodiments, the second interfaces also comprise a button for sending exam sheets in the Worklist thereof to the distribution unit to redistribute the exam sheets.

In some embodiments, the distribution principle is configurable.

One technical effect of the present invention is that, because exam sheets can be automatically sent to doctors and the doctors are not required to manually select the exam sheets, the work efficiency is greatly improved.

Second, the exam sheets can be handled on time, and there will be no exam sheet that is not handled by the doctors for a long period of time.

Third, a doctor further can forward exam sheets in his Worklist to other doctors, and stop or continue to send exam sheets to his Worklist, such that each doctor will not come within the situation where exam sheets are too many for him to handle.

In addition, exam sheets can be sent pertinently to exact doctors in accordance with subscription conditions, thus accuracy can be greatly improved.

### BRIEF DESCRIPTION OF THE DRAWINGS

In order to understand the contents disclosed in the present text more thoroughly, description is hereby given as follows in combination with the figures, wherein:

FIG. 1 is a schematic diagram of the exam sheet handling system of the present invention;

FIG. 2 is an interface setting and changing subscription conditions;

FIG. 3 is an interface of a Worklist;

FIG. 4 is an interface of a window of selecting a forward object;

FIG. 5 is a flowchart of the exam sheet handling method of the present invention;

FIG. 6 is an example of an interface for selecting a distribution principle.

### DETAILED DESCRIPTION OF THE INVENTION

The specific embodiments of the present invention will be described in detail as follows, however, the present invention is not limited to the following specific embodiments.

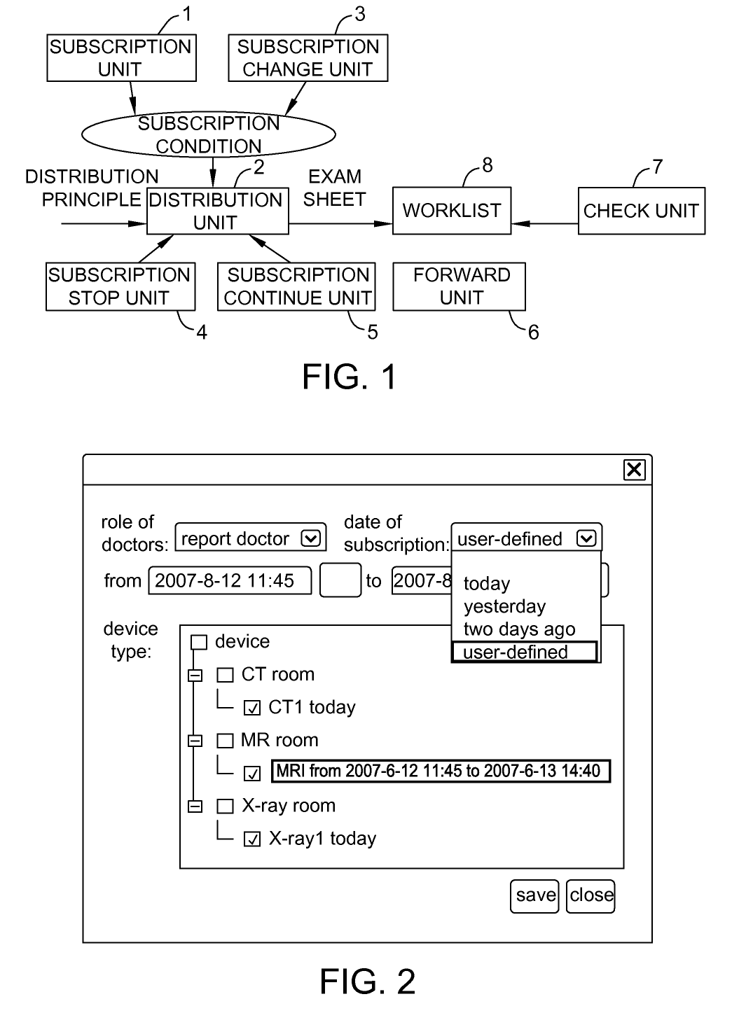

As shown in FIG. 1, it discloses an exam sheet handling system, comprising:

a subscription unit 1 for setting subscription conditions for doctors and a distribution unit 2 for sending exam sheets to Worklists 8 of the doctors in accordance with said subscription conditions and a distribution principle.

It can be seen that a doctor may set subscription conditions through the subscription unit 1, in other words, a doctor may subscribe exam sheets adapted to him in accordance with his expertise. The distribution unit 2 sends exam sheets adapted to a certain doctor to the Worklist 8 of the doctor in accordance with the subscription conditions set and the distribution principle. Thus the doctor only needs to open his own Worklist 8 and handle exam sheets in the Worklist 8, while he does not need to retrieve whether there are exam sheets adapted to him, such that the work efficiency of the doctor is improved.

Said subscription unit 1 can be realized by the interface shown in FIG. 2, comprising role of doctors, time range of exams, and type of exams (which can be classified according to device, or classified according to diagnosis type, or classified according to lesion site and etc.).

If classified according to device, the type of exams may include: radiology devices (MR, CT, X-ray, ultrasonic, etc.), other exam/test devices (ECG, blood routine, gastroscope, blood pressure, etc.).

If classified according to diagnosis type, the type of exams may include: department of neurology, neurosurgery, cardiovascular disease and etc.

If classified according to lesion site, the type of exams may include: head, abdomen, cervical vertebrae, lumbar vertebrae, liver, enterogastric, renal and etc.

As for the distribution principle, it is configurable.

For example, configuration may be implemented by the interface shown in FIG. 6, that is, selecting a distribution principle therefrom, said principles in the interface including distributing workload in same proportion, distributing in accordance with expert level of doctors, and the doctor having the minimal workload in the Worklist, and so forth.

Besides, new principles may be added into the interface shown in FIG. 6 through adding new Class, and then the new principles can be selected for use in the interface.

The distribution principle may adopt the mode of distributing evenly exam sheets satisfying the subscription conditions to doctors who have subscribed said exam sheets, for example, there are five doctors who have subscribed exam sheets of exams implemented on patients by a CT device from Jun. 12, 2007 to Jun. 14, 2007, and there are ten exam sheets satisfying the subscription conditions, then each doctor may be distributed with two exam sheets. Said distribution principle also may adopt the mode of distributing the exam sheets satisfying the subscription conditions to the doctor who have the minimal uncompleted workload in his Worklist 8 among all the doctors who have subscribed the exam sheets, for example, there are five doctors who have subscribed exam sheets of exams implemented on patients by a CT device from Jun. 12, 2007 to Jun. 14, 2007, and there are ten exam sheets satisfying the subscription conditions, then firstly, each of the five doctors is distributed with one exam sheet, if doctor A has completed handling exam sheets prior to the other doctors, then the sixth exam sheet is distributed to doctor A, and so on. Of course, the distribution principle also may adopt any other mode.

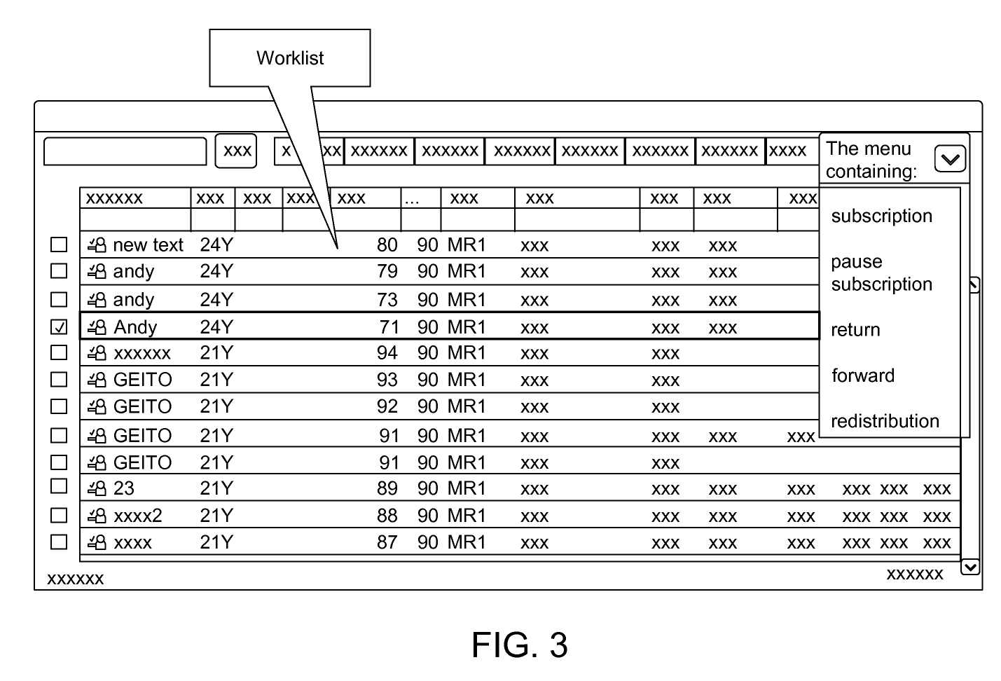

As shown in FIG. 3, it illustrates Worklist 8 of a doctor, comprising: a list of exam sheets distributed to the present doctor and some information of the exam sheets, for example, name, sex, exam device, exam method, source, and etc. A doctor may select an exam sheet therefrom to handle it, and write a corresponding report of exam.

And as shown in FIG. 1, the exam sheet handling system of the present invention also comprises a subscription change unit 3 for changing said subscription conditions; a subscription stop unit 4 for disabling said distribution unit 2 and a subscription continue unit 5 for enabling said distribution unit 2; a forward unit 6 for forwarding exam sheets in said Worklist 8 to other Worklist 8 and a check unit 7 for checking whether exam sheets in said Worklist 8 satisfy said subscription conditions and removing or maintaining said exam sheets in accordance with instructions of the doctors.

Said subscription change unit 3 may change the subscription conditions set by the subscription unit 1, and it also can be realized by the interface shown in FIG. 2, it can change the subscription conditions through changing role of doctors, time range of subscription, type of exams and etc. For example, doctor A initially only subscribes the exam sheets that device CT1 corresponds to, afterwards, with improvement of the work proficiency level, doctor A may modify the subscription conditions to exam sheets of two devices CT1 and CT2. In other words, when the expertise, leisure time and etc. of a doctor change, the subscription conditions may be changed by the subscription change unit 3, that is, exam sheets sent to the Worklist 8 of the doctor are redirected.

If a certain doctor has too many exam sheets in his Worklist 8, he may stop sending exam sheets to his Worklist 8 by the subscription stop unit 4, the subscription stop unit 4 can be realized by “pause subscription” in the interface as shown in FIG. 3, of course, other modes also can be used to disable the distribution unit 2 from distributing exam sheets to him.

After the distribution unit 4 is disabled from sending exam sheets to the Worklist 8 of the doctor, the distribution unit 4 can be restarted by the subscription continue unit 5 to be enabled it to continue to send exam sheets to the Worklist 8 of the doctor, the subscription continue unit 5 is realized by “continue” in the interface as shown in FIG. 3, that is, restarting the distribution unit 4 to enabling it to continue to send exam sheets to the Worklist 8 of the doctor.

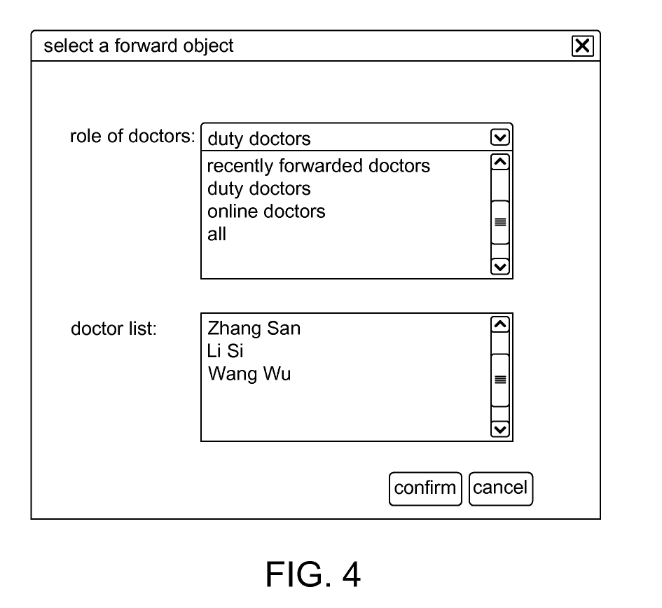

If a doctor cannot handle a certain exam sheet in his Worklist 8, the exam sheet can be sent to the Worklist 8 of other doctors by the forward unit 6, the forward unit 6 is realized by the interface as shown in FIG. 4, the interface shown in FIG. 4 is invoked by the “forward” option in the interface shown in FIG. 3. The doctor firstly selects an exam sheet in the Worklist 8, then clicks “forward”, then the “select a forward object” window as shown in FIG. 4 will be displayed, herein, the role of doctors and the doctor that the forwarding directs at are selected in the “select a forward object” window, that is, the exam sheet can be forwarded to a specified doctor.

And as shown in FIG. 3, a doctor may send back exam sheets in his Worklist 8 to the distribution unit 2 and have the distribution unit 2 redistribute the exam sheets, for example, through clicking “redistribution” option in the interface to realize the redistribution.

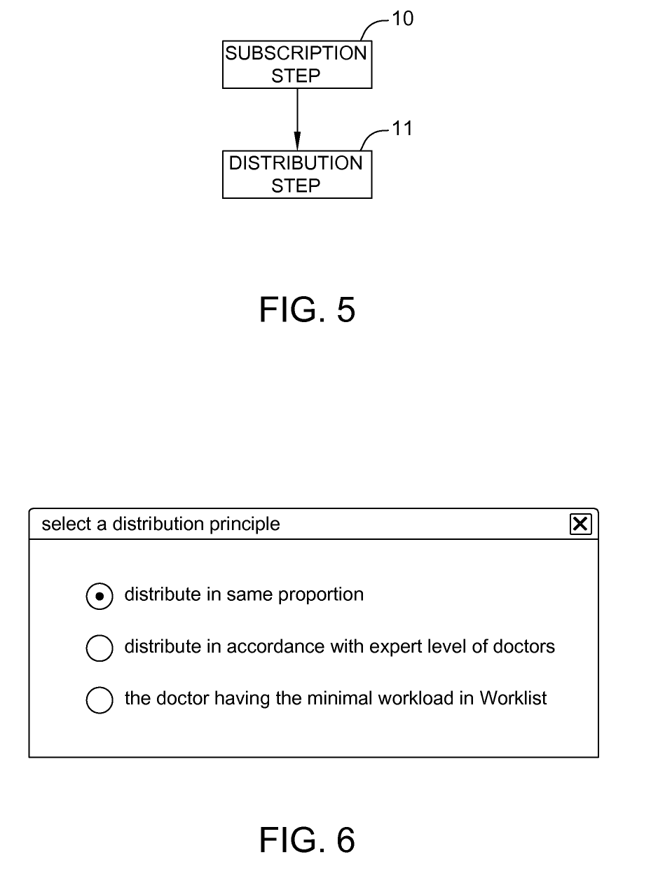

As shown in FIG. 5, the present invention also discloses an exam sheet handling method, which includes setting (10) subscription conditions for doctors, and sending (11) exam sheets to a Worklist of the doctors in accordance with the subscription conditions and a distribution principle.

A doctor sets subscription conditions for exam sheets distributed to him, that is, exam sheets satisfying what kind of conditions can be distributed to the doctor. The subscription conditions may include role of doctors, time range of exams, and type of exams (which can be classified according to device, or classified according to diagnosis type, or classified according to lesion site and etc.). Then, exam sheets satisfying said subscription conditions are sent to the Worklist of the doctor in accordance with certain distribution principle, so each doctor only needs to check his own Worklist and handle the exam sheets in his Worklist.

Said distribution principle is configurable.

For example, configuration may be implemented by the interface shown in FIG. 6, that is, selecting a distribution principle therefrom, said principles in the interface including distributing in same proportion, distributing in accordance with the expert level of the doctors, doctor having the minimal workload in the Worklist, and so forth.

Besides, new principles may be added into the interface shown in FIG. 6 through adding new Class, and then the new principles can be selected for use in the interface.

The distribution principle may adopt the mode of distributing evenly exam sheets satisfying the subscription conditions to doctors who have subscribed said exam sheets, for example, there are five doctors who have subscribed exam sheets of exams implemented on patients by a CT device from Jun. 12, 2007 to Jun. 14, 2007, and there are ten exam sheets satisfying the subscription conditions, then each doctor may be distributed with two exam sheets. Said distribution principle also may adopt the mode of distributing the exam sheets satisfying the subscription conditions to the doctor who have the minimal uncompleted workload in his Worklist 8 among all the doctors who have subscribed the exam sheets, for example, there are five doctors who have subscribed exam sheets of exams implemented on patients by a CT device from Jun. 12, 2007 to Jun. 14, 2007, and there are ten exam sheets satisfying the subscription conditions, then firstly, each of the five doctors is distributed with one exam sheet, if doctor A has completed handling exam sheets prior to the other doctors, then the sixth exam sheet is distributed to doctor A, and so on. Of course, the distribution principle also may adopt any other mode.

Further, the exam sheet handling method of the present invention also comprises subscription change step for changing said subscription conditions. That is, a doctor may change the subscription conditions, as shown in FIG. 2.

Further, the exam sheet handling method of the present invention also comprises subscription stop step for disabling said distribution step and subscription continue step for enabling said distribution step, in other words, not receiving new exam sheets and continue to receive new exam sheets, as shown in FIG. 3. In addition, in case such as it is hard for the doctor to give an exam report for a certain exam sheet, or it is inconvenient for him to give an exam report owing to certain reason, and so forth, the exam sheet may be forwarded to the Worklist 8 of other doctors, as shown in FIG. 4, the interface shown in FIG. 4 is invoked by the “forward” option in the interface shown in FIG. 3. The doctor firstly selects an exam sheet in the Worklist 8, thereafter he clicks “forward”, then the “select a forward object” window as shown in FIG. 4 can be displayed, herein, the role of doctors and the doctor that the forwarding directs at are selected in the “select a forward object” window, that is, the exam sheet can be forwarded to a specified doctor.

Because the subscription conditions may be changed, it is not guaranteed that all the exam sheets in the Worklist 8 of a certain doctor satisfy the subscription conditions at present, accordingly, the exam sheets in said Worklist 8 are needed to be checked termly or in real time to judge whether they satisfy said subscription conditions and to remove or delete said exam sheets according to instructions of the doctor.

The present invention also discloses an exam sheet handling system, including a first interface for setting subscription conditions, wherein the first interface includes role of doctors, time range of exams, and type of exams. The exam sheet handling system also includes a plurality of second interfaces corresponding to each doctor, wherein the second interfaces include Worklist of the doctors. The exam sheet handling system further includes a distribution unit for sending exam sheets to the Worklist in the second interfaces in accordance with the subscription conditions set by the first interface and a distribution principle.

Wherein said first interface may be realized by the interface as shown in FIG. 2; said second interfaces may be realized by the interface as shown in FIG. 3.

Moreover, said first interface further can be used for changing the subscription conditions.

Further, said second interfaces also comprise an option for disabling said distribution unit from sending exam sheets to the Worklist therein, e.g. the “pause subscription” option shown in FIG. 3.

The exam sheet handling system of the present invention also comprises a third interface for forwarding exam sheets in said Worklist to other Worklist in the second interfaces that other doctors correspond to, as shown in FIG. 4, said third interface is invoked by said second interfaces, for example, it is invoked by the “forward” option shown in FIG. 3. Said third interface may include role of doctors, doctor list and so forth.

Moreover, said second interfaces also comprise a button for sending exam sheets in the Worklist therein to said distribution unit to redistribute the exam sheets, for example, the “redistribution” button shown in FIG. 3.

As for said distribution principle, it is configurable.

For example, configuration may be implemented by the interface shown in FIG. 6, that is, selecting a distribution principle therefrom, said principles in the interface including distributing in same proportion, distributing in accordance with expert level of doctors, the doctor having the minimal workload in the Worklist, and so on.

Moreover, new principles may be added into the interface as shown in FIG. 6 through adding new Class and etc., and then the new principles may be selected for use in the interface.

The distribution principle may adopt the mode of distributing evenly exam sheets satisfying the subscription conditions to doctors who have subscribed said exam sheets, for example, there are five doctors who have subscribed exam sheets of exams implemented on patients by a CT device from Jun. 12, 2007 to Jun. 14, 2007, and there are ten exam sheets satisfying the subscription conditions, then each doctor may be distributed with two exam sheets. Said distribution principle also may adopt the mode of distributing the exam sheets satisfying the subscription conditions to the doctor who have the minimal uncompleted workload in his Worklist 8 among all the doctors who have subscribed the exam sheets, for example, there are five doctors who have subscribed exam sheets of exams implemented on patients by a CT device from Jun. 12, 2007 to Jun. 14, 2007, and there are ten exam sheets satisfying the subscription conditions, then firstly, each of the five doctors is distributed with one exam sheet, if doctor A has completed handling exam sheets prior to the other doctors, then the sixth exam sheet is distributed to doctor A, and so on. Of course, the distribution principle also may adopt any other mode.

Although the specific embodiments of the present invention have been described as above in combination with the figures, yet those skilled in the art may make numerous changes, variations and equivalents on the present invention without departing from the scope thereof. Accordingly, it is intended that such changes, variations and equivalents fall within the scope as set forth in the appended claims thereof.

1. An exam sheet handling system, comprising:
a subscription unit configured to set subscription conditions for a plurality of doctors; and
a distribution unit configured to send at least one exam sheet to a respective Worklist of each of the plurality of doctors in accordance with the subscription conditions and a distribution principle.

2. The exam sheet handling system according to claim 1, further comprising a subscription change unit configured to change the subscription conditions.

3. The exam sheet handling system according to claim 2, further comprising a subscription stop unit configured to disable said distribution unit and a subscription continue unit configured to enable said distribution unit.

4. The exam sheet handling system according to claim 3, further comprising a forward unit configured to forward the at least one exam sheet in said a first Worklist to a second Worklist.

5. The exam sheet handling system according to claim 4, further comprising a check unit configured to determine whether exam sheets in a Worklist satisfy said the subscription conditions and to remove or maintain the exam sheets in accordance with instructions of at least one of the plurality of doctors.

6. The exam sheet handling system according to claim 1, wherein the distribution principle is configurable.

7. The exam sheet handling system according to claim 6, wherein said distribution unit is configured to use the distribution principle to distribute new exam sheets evenly to doctors who have subscribed to the exam sheets.

8. The exam sheet handling system according to claim 6, wherein said distribution unit is configured to use the distribution principle to distribute new exam sheets to a doctor of the plurality of doctors who has a minimal uncompleted workload in his Worklist among doctors who have subscribed to the exam sheets.

9. An exam sheet handling method, comprising:
setting subscription conditions for a plurality of doctors; and
sending exam sheets to a respective Worklist of each of the plurality of doctors in accordance with the subscription conditions and a distribution principle.

10. The exam sheet handling method according to claim 9, further comprising changing the subscription conditions.

11. The exam sheet handling method according to claim 10, further comprising disabling the distribution step enabling the distribution step.

12. The exam sheet handling method according to claim 11, further comprising forwarding exam sheets in a first Worklist of a first doctor of the plurality of doctors to a second Worklist of a second doctor of the plurality of doctors.

13. The exam sheet handling method according to claim 12, further comprising checking whether exam sheets in a Worklist satisfy the subscription conditions and removing or maintaining the exam sheets in accordance with instructions of at least one of the plurality of doctors.

14. The exam sheet handling method according to claim 9, wherein the distribution principle is configurable.

15. An exam sheet handling system, comprising:
a first interface configured to set subscription conditions, said first interface comprising a role of a plurality of doctors, a time range of exams, and a type of exams;
a plurality of second interfaces corresponding to each of the doctors, each of said second interfaces comprising a Worklist for each of the plurality of doctors; and
a distribution unit configured to send exam sheets to a Worklist in at least one of said plurality of second interfaces in accordance with the subscription conditions set by said first interface and a distribution principle.

16. The exam sheet handling system according to claim 15, said first interface is further configured to change the subscription conditions.

17. The exam sheet handling system according to claim 16, each of said plurality of second interfaces further comprises an option for disabling said distribution unit from sending exam sheets to the Worklist therein.

18. The exam sheet handling system according to claim 17, further comprising a third interface configured to forward exam sheets in a first Worklist to a second Worklist in, said third interface being invoked by one of said plurality of second interfaces associated with the first Worklist or the second Worklist.

19. The exam sheet handling system according to claim 18, each of said plurality of second interfaces further comprises a button for sending exam sheets in the Worklist therein to said distribution unit for redistribution.

20. The exam sheet handling system according to claim 15, wherein the distribution principle is configurable.
